(19) United States
(12) Patent Application Publication
(10) Pub. No.: US 2004/0177759 A1
(43) Pub. Date: Sep. 16, 2004

(54) Triboelectric air filter media

(76) Inventors: Peter P. Tsai, Knoxville, TN (US); Liang-Yu Chang, Tainan (TW)

Correspondence Address: TROP PRUNER & HU, PC, 8554 KATY FREEWAY, SUITE 100, HOUSTON, TX, 77024, US

(21) Appl. No.: 10/389,115

(22) Filed: Mar. 14, 2003

(51) Int. Cl. B01D 46/00

(52) U.S. Cl. 96/66; 55/528

(57) ABSTRACT

A triboelectric air filter media is formed as a blend of polyolefin fibers and melamine fibers. The blend of polyolefin fibers and melamine fibers is carded in a carding machine so as to charge polyolefin fibers and melamine fibers with static charges. The weight ratio of polyolefin fibers to melamine fibers is in the range between 10:90 and 90:10.

### BACKGROUND OF THE INVENTION

1. Field of the Invention

This invention relates to a triboelectric air filter media, more particularly to a triboelectric air filter media formed as a blend of polyolefin fibers and melamine fibers.

2. Description of the Related Art

Filtration efficiency for capturing airborne particles can be controlled in a mechanical way or through an electrostatic mechanism. The electrostatic mechanism uses an electrostatic fibrous material that carries electric charges to attract airborne particles carried by an air flow passing therethrough so as to enhance filtration efficiency without increasing air flow resistance.

Tsai et al., “Particulate Science and Technology”, (12), 323-332, 1994, provides a study of filtration efficiency for various electrostatic charged fibrous materials.

Filtration efficiency of electrostatic fibrous materials is mainly controlled by parameters such as, electrical charge density, electric field strength, and durability for sustaining the least electric field strength. An ideal electrostatic fibrous material is one having a durability such that the fibrous material can carry a relatively high density of electric charge till the end of its life time. Durability of an electrostatic fibrous material is mainly controlled by the type of the fibrous material used and by how the electric charge is formed. Formation of electric charge on the fibrous material can be carried out by the following known art: (1) Electrostatic Spinning techniques, which are mainly used for the production of ultra fine fibers; (2) Corona Charging techniques, which involve using a high voltage electrode to dissociate air molecules therearound and to attract the dissociated electrons, thereby resulting in charging of a fibrous material that is mounted on the electrode (see U.S. Pat. No. 5,401,446 and Tsai et al., “TAPPI Journal”, Vol. 81, No. 1, January, 1998); and (3) Triboelectrification Charging techniques, which card at least two different fibers having different electronegative properties to generate static charge on the fibers (see Smith et al, “Journal of Electrostatics”, 1988, Vol. 21, 81-89).

The following patents relate to an air filter material formed according to the aforesaid Triboelectrification Charging techniques.

British Patent Specification No. 2,190,689 discloses a triboelectric air filter media comprising a blend of polyolefin fibers and fibers of another polymer containing hydrocarbon functions substituted by halogen atoms.

U.S. Pat. No. 4,798,850 discloses a triboelectric air filter media comprising a blend of polyolefin fibers and fibers of a polymer comprising one or more halogen-substituted hydrocarbons.

U.S. Pat. No. 5,368,734 discloses a triboelectric air filter media comprising a blend of clean expanded porous polytetrafluoroethylene fibers and clean polyamide fibers.

U.S. Pat. No. 5,470,485 discloses a triboelectric air filter media comprising a blend of polyolefin fibers of two component polypropylene/polyethylene and halogen-free polyacrylonitrile fibers.

U.S. Pat. No. 6,328,788 discloses a triboelectric air filter media comprising a blend of polypropylene fibers and polymethaphenylene isophthalamide fibers.

The triboelectric air filter media disclosed in the aforementioned patents are disadvantageous in that the raw materials for the production of the triboelectric air filter media are relatively expensive or are commercially unavailable.

### SUMMARY OF THE INVENTION

Therefore, the objective of the present invention is to provide a triboelectric air filter media that is capable of overcoming the aforementioned drawbacks of the prior art.

According to the present invention, there is provided a triboelectric air filter media that comprises a blend of polyolefin fibers and melamine fibers.

### DETAILED DESCRIPTION OF THE PREFERRED EMBODIMENT

A triboelectric air filter media formed according to the present invention comprises a blend of polyolefin fibers and melamine fibers which are carded using a carding machine so as to form static charge on the fibers.

Suitable polyolefin fibers are those having electronegative property different from that of polyamide fibers. Preferably, polyolefin fibers are made from a compound selected from the group consisting of polyethylene, polypropylene, polybutylene, and mixtures thereof, and are more preferably made from polypropylene.

The weight ratio of polyolefin fibers to melamine fibers preferably ranges between 10:90 and 90:10, and more preferably ranges between 20:80 and 80:20. Preferably, the weight ratio of polyolefin fibers to melamine fibers is 75:25, more preferably 50:50, and most preferably 25:75.

The dimensions, i.e. staple length and diameter, of polyolefin fibers and melamine fibers used for forming the triboelectric air filter media of this invention are preferably within a range that is suitable for carding according to the type of carding machine used. The deviation between the surface areas of polyolefin fibers and melamine fibers should be kept as small as possible so as to maximize the friction area and so as to enhance the filtration efficiency.

The triboelectric air filter media of this invention can be made into felt, woven or non-woven fabric, or knitted fabric by various known techniques, such as cross-lapping, yarn spinning, needle punching, and knitting.

Polyolefin fibers and melamine fibers are preferably free of any solvent, lubricant, or any anti-static medium before being blended together. Any anti-static medium present can be removed by washing in an aqueous surfactant bath and rinsing with de-ionized water.

### EXAMPLES

The following examples of the triboelectric air filter media of this invention differ in the weight ratio of polyolefin fibers to melamine fibers and were subjected to Quality Factor (Q_{f}) test using TSI Automated Filter Testers 8130 for evaluating the quality of the examples. The Quality Factor (Q_{f}) is represented by the following formula

$${Q}_{f} = \frac{ln ( \frac{1}{1 - FE} )}{Δ P} ,$$

wherein FE represents the filtration efficiency, and ΔP is the pressure drop for air to flow through the filter media. A higher value of Q_{f} represents higher quality.

The Q_{f} test was based on the following conditions:

Type of aerosol: sodium chloride.

Mass Mean Diameter of aerosol particulates: 0.26 micron.

Geometric Standard Deviation of aerosol particulates: less than 1.83.

Filtration face velocity: 5.3 cm/s.

Polypropylene fibers: (2 denier)×64 mm (brand name P-2N, purchased from Taiwan True Young Co., Ltd.).

Melamine fibers: (2.5 denier)×2 inches, density=1.4 grams/cm³, tenacity=2.0 grams/denier, (brand name basofil, purchased from BASF Group, Germany).

The triboelectric air filter media in each Example was prepared by blending the above specified polyolefin fibers and melamine fibers in a beating opener, subsequently carding and cross-lapping the fibers in a carding machine so as to charge the fibers, needle punching the lapped fibers, followed by forming the lapped fibers into a non-woven fabric.

Table 1 illustrates the Q_{f} test results of Examples 1 to 3.

TABLE 1

| | Example | | |
|---|---|---|---|
| | 1 | 2 | 3 |
| Weight ratio* | 25:75 | 50:50 | 75:25 |
| FE, % | 96.60 | 96.13 | 93.88 |
| Δ P, mmH₂O | 0.7 | 0.7 | 0.7 |
| Q_{f}, mmH₂O⁻¹ | 4.83 | 4.65 | 3.99 |

*polyolefin fibers:melamine fibers

Results of the Q_{f} test show that the triboelectric air filter media of this invention has a relatively high quality factor (Q_{f}). The Q_{f} reaches 4.83 mmH₂O⁻¹ when the weight ratio of polyolefin fibers to melamine fibers is about 25:75. The group of polyolefin fibers and the group of melamine fibers, which are preferably used in this invention, are commercially available and price competitive in comparison with those of the prior art described hereinabove.

With the invention thus explained, it is apparent that various modifications and variations can be made without departing from the spirit of the present invention. It is therefore intended that the invention be limited only as recited in the appended claims.

We claim:

1. A triboelectric air filter media comprising:
a blend of polyolefin fibers and melamine fibers.

2. The triboelectric air filter media of claim 1, wherein said polyolefin fibers are made from a compound selected from the group consisting of polyethylene, polypropylene, polybutylene, and mixtures thereof.

3. The triboelectric air filter media of claim 2, wherein said polyolefin fibers are made from polypropylene.

4. The triboelectric air filter media of claim 1, wherein the weight ratio of said polyolefin fibers to said melamine fibers ranges between 10:90 and 90:10.

5. The triboelectric air filter media of claim 4, wherein the weight ratio of said polyolefin fibers to said melamine fibers ranges between 20:80 and 80:20.

6. The triboelectric air filter media of claim 5, wherein the weight ratio of said polyolefin fibers to said melamine fibers is 25:75.

7. The triboelectric air filter media of claim 5, wherein the weight ratio of said polyolefin fibers to said melamine fibers is 50:50.

8. The triboelectric air filter media of claim 5, wherein the weight ratio of said polyolefin fibers to said melamine fibers is 75:25.
